(19) United States
(12) Patent Application Publication
(10) Pub. No.: US 2024/0046119 A1
(43) Pub. Date: Feb. 8, 2024

(54) VALUE CHAIN KNOWLEDGE DISCOVERY METHOD UNDER PERSONALIZED CUSTOMIZATION

(71) Applicant: GUANGZHOU UNIVERSITY, Guangzhou (CN)

(72) Inventors: Yongjun HU, Guangzhou (CN); Liuqian ZHU, Guangzhou (CN)

(73) Assignee: GUANGZHOU UNIVERSITY, Guangzhou (CN)

(21) Appl. No.: 18/278,654

(22) PCT Filed: Dec. 13, 2022
(86) PCT No.: PCT/CN2022/138678

§ 371 Date: Aug. 24, 2023

(30) Foreign Application Priority Data
Jun. 23, 2022 (CN) 202210715356.8

(51) Int. Cl. G06N 5/022

(52) U.S. Cl. CPC G06N 5/022

(57) ABSTRACT

A value chain knowledge discovery method under personalized customization is provided. The method comprises the following steps: defining a value topic for a given domain text, and extracting a value anchoring seed word; constructing a value semantic topological space according to the value anchoring seed word; expanding the value anchoring seed word to obtain an initial topic anchoring word set; updating the initial topic anchoring word to obtain an optimized topic anchoring word set; obtaining a multi-cluster net structure representation of a value semantic text by taking the optimized topic anchoring word as a constraint; and anchoring and constraining a plurality of cross-domain texts to construct a value chain knowledge graph.

### CROSS REFERENCE TO THE RELATED APPLICATIONS

This application is the national phase entry of International Application No. PCT/CN2022/138678, filed on Dec. 13, 2022, which is based upon and claims priority to Chinese Patent Application No. 202210715356.8, filed on Jun. 23, 2022, the entire contents of which are incorporated herein by reference.

### TECHNICAL FIELD

The present invention relates to the technical field of information, and in particular to a value chain knowledge discovery method under personalized customization.

### BACKGROUND

The current mainstream natural language processing methods comprise high-frequency word analysis, SOA triple extraction, LDA topic model, deep neural network, and the like, and however, these methods have the problems of low knowledge mining accuracy, dependence on preset dictionaries, difficult alignment of cross-domain knowledge semantic representation and the like. Although the deep neural network has a better effect, the algorithm seriously depends on the equipment operation capability, takes a large amount of time, corpus labels and the like for modeling analysis, and the unexplainable property of the model also seriously restricts the application of the algorithm; therefore, there is a need for a knowledge discovery method with high knowledge mining accuracy, independence on preset dictionaries, easy alignment of cross-domain knowledge semantic representation, low operation requirement, and wide application range. The anchoring phenomenon of a ship can inspire semantic anchoring and aligning representation of multi-source complex innovative information, and by anchoring semantic information in a text, the text key information can be effectively captured, so that the information can be more efficiently represented.

### SUMMARY

In view of this, the present invention provides a value chain knowledge discovery method under personalized customization, which quickly locks the topic semantics of the current layer through a small number of labels and anchoring seed words, constructs a semantic topological space, and excavates a text core content by using anchoring semantics and a topological persistent homology technique to obtain a text semantic topic feature, thereby quickly excavating the knowledge of the text.

In order to achieve the above objective, the present invention provides the following technical solutions.

A value chain knowledge discovery method under personalized customization comprises the following steps:
S1: defining a value topic for a given domain text, and extracting a value anchoring seed word;
S2: constructing a value semantic topological space according to the value anchoring seed word;
S3: expanding the value anchoring seed word to obtain an initial topic anchoring word set;
S4: updating the initial topic anchoring word to obtain an optimized topic anchoring word set;
S5: obtaining a multi-cluster net structure representation of a value semantic text by taking the optimized topic anchoring word as a constraint; and
S6: repeating the steps S1-S5 on a plurality of cross-domain texts for anchoring and constraining to construct a value chain knowledge graph.

Preferably, the step S1 specifically comprises: performing word segmentation on the given domain text to obtain a text word sequence and defining the value topic, extracting a concept noun and a description word in the text word sequence as initial words, performing coding processing on the concept noun and the description word by using a general text coding method to obtain a word text vector under a general corpus, calculating a semantic distance between every two initial words in the value topic, and finding out at least 3 words with the closest semantic distances from other initial word in each topic as value anchoring seed words.

Preferably, the step S2 specifically comprises: calculating a semantic distance between the value anchoring seed word and other words in the given domain text; and removing a word with a semantic distance that is from the value anchoring seed word and that is larger than a first preset threshold, and converting a text measurement space taking the value anchoring seed word as a center into the value semantic topological space through a preset topological persistent homology parameter.

Preferably, the step S3 specifically comprises: in a value topic of the value semantic topological space, taking the number of value anchoring seed words with semantic distances that are from topic words and that are smaller than a first preset threshold as the number of hits of the topic words on the value anchoring seed words, calculating an anchoring hit probability of the topic words in the value topic according to the number of hits, expanding the topic words with the anchoring hit probability larger than 50% into the value anchoring seed words as expansion words, and obtaining the initial topic anchoring word set formed by the value anchoring seed words and the expansion words.

Preferably, the step S4 specifically comprises: in a value topic of the value semantic topological space, selecting any one of the initial topic anchoring words, counting semantic distances between the selected initial topic anchoring word and other initial topic anchoring words, taking the number of other initial topic anchoring words with semantic distances that are from the selected initial topic anchoring word and that are smaller than a second preset threshold as the number of hits, calculating a hit probability of each selected initial topic anchoring word in the initial topic anchoring word set according to the number of hits, taking the first 3 initial topic anchoring words with the highest hit probability as new anchoring seed words, taking the new anchoring seed words as initial anchoring seed words, and repeating the step S3 to obtain the optimized topic anchoring word set.

Preferably, the step S5 specifically comprises: in the value semantic topological space, calculating semantic distances between an optimized topic anchoring word and other words of the given domain text, classifying a word with a semantic distance that is from the optimized topic anchoring word and that is smaller than a third preset threshold into a value topic to which the optimized topic anchoring word belongs, aggregating a text content that is in the value topic and that has a semantic distance smaller than a fourth threshold by taking a given personalized customized decision target as a constraint, and obtaining an evolution rule of the value topic according to time window analysis; performing “main body-description” chain structure representation on the value topic based on the personalized customized decision target to obtain multi-chain aggregated net structure topic representation; and converting an anchoring hit relation between words into a connection relation, performing topological persistent homology on the value semantic topological space by taking the optimized topic anchoring word as a constraint, adjusting a density of word connection in the semantic topological space, and if the connection density between the optimized topic anchoring word and related words in the value topic is greater than that between the optimized topic anchoring word and related words in other topics, forming multi-cluster net structure representation of the value semantic text on this basis.

Preferably, the step S6 specifically comprises: in the value semantic topological space, performing knowledge representation under anchoring semantics on other cross-domain text corpora by the steps S1-S5, performing topological persistent homology on the cross-domain text based on a given decision target to obtain a semantic feature of value alignment in the cross-domain text, extracting a cross-domain and multi-body association relationship based on the semantic feature of the given decision target, and obtaining the value chain knowledge graph with texts as nodes and text association relationships as connections.

It can be seen from the above technical solutions that, compared with the prior art, the present invention discloses and provides a value chain knowledge discovery method based on anchoring semantics, which has the following beneficial effects such as high knowledge mining accuracy rate, high capability of knowledge on decision representation, independence on preset dictionaries, easy alignment of cross-domain knowledge semantic representation, low operation requirement, and wide application range. According to the present invention, based on the description of different types of texts on the same domain, event evolution rules can be analyzed from a plurality of trends, patent texts and consumer-side comment texts are taken as examples, the technology development trend and technology evolution trend of the industry are mined by analyzing a patent-side technology of a certain product, consumer-side public opinion, news topic discussion and the like are matched, the technology-side development trends are combined with consumer requirements, and the innovation value chain of the product is extracted and analyzed, so that the technology application development prospect is determined, and support is provided for the decision.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are merely embodiments of the present invention, and those of ordinary skill in the art can obtain other drawings according to the drawings provided without creative efforts.

FIG. 1 is a schematic flowchart according to the present invention; and

FIG. 2 is a schematic diagram of a topological persistent isomorphism optimization process according to the present invention.

### DETAILED DESCRIPTION OF THE EMBODIMENTS

The following clearly and completely describes the technical solutions in embodiments of the present invention with reference to the accompanying drawings in embodiments of the present invention. It is clear that the described embodiments are merely a part rather than all of embodiments of the present invention. Based on the embodiments of the present invention, all other embodiments obtained by those of ordinary skill in the art without creative efforts shall fall within the protection scope of the present invention.

### Embodiment 1

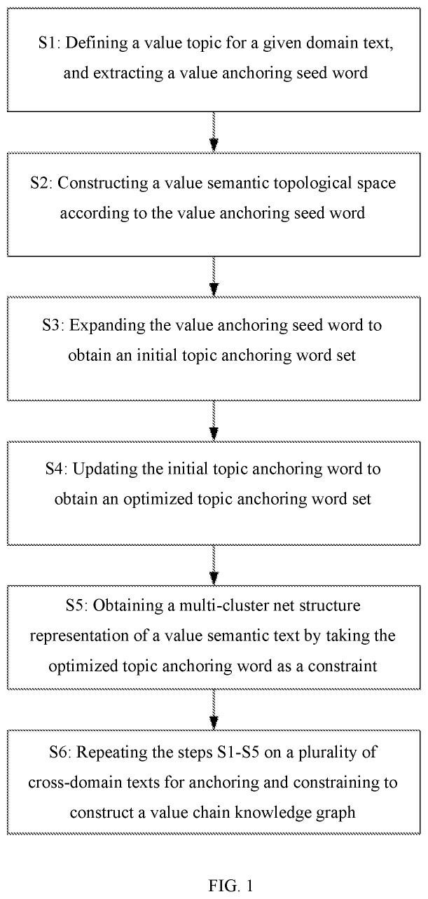

A value chain knowledge discovery method under personalized customization, as shown in FIG. 1, comprises the following steps:

S1: defining a value topic for a given domain text, and extracting a value anchoring seed word; specifically, performing word segmentation on the given domain text to obtain a text word sequence and defining the value topic, extracting a concept noun and a description word in the text word sequence as initial words, performing coding processing on the concept noun and the description word by using a general text coding method to obtain a word text vector under a general corpus, calculating a semantic distance between every two initial words in the value topic, and finding out at least 3 words with the closest semantic distances from other initial word in each topic as value anchoring seed words.

S2: constructing a value semantic topological space according to the value anchoring seed word; specifically, calculating a semantic distance between the value anchoring seed word and other words in the given domain text; and removing a word with a semantic distance that is from the value anchoring seed word and that is larger than a first preset threshold, and converting a text measurement space taking the value anchoring seed word as a center into the value semantic topological space through a preset topological persistent homology parameter.

S3: expanding the value anchoring seed word to obtain an initial topic anchoring word set; specifically, in a value topic of the value semantic topological space, taking the number of value anchoring seed words with semantic distances that are from topic words and that are smaller than a first preset threshold as the number of hits of the topic words on the value anchoring seed words, calculating an anchoring hit probability of the topic words in the value topic according to the number of hits, expanding the topic words with the anchoring hit probability larger than 50% into the value anchoring seed words as expansion words, and obtaining the initial topic anchoring word set formed by the value anchoring seed words and the expansion words.

S4: updating the initial topic anchoring word to obtain an optimized topic anchoring word set; specifically, in a value topic of the value semantic topological space, selecting any one of the initial topic anchoring words, counting semantic distances between the selected initial topic anchoring word and other initial topic anchoring words, taking the number of other initial topic anchoring words with semantic distances that are from the selected initial topic anchoring word and that are smaller than a second preset threshold as the number of hits, calculating a hit probability of each selected initial topic anchoring word in the initial topic anchoring word set according to the number of hits, taking the first 3 initial topic anchoring words with the highest hit probability as new anchoring seed words, taking the new anchoring seed words as initial anchoring seed words, and repeating the step S3 to obtain the optimized topic anchoring word set.

S5: obtaining a multi-cluster net structure representation of a value semantic text by taking the optimized topic anchoring word as a constraint; specifically, in the value semantic topological space, calculating semantic distances between an optimized topic anchoring word and other words of the given domain text, classifying a word with a semantic distance that is from the optimized topic anchoring word and that is smaller than a third preset threshold into a value topic to which the optimized topic anchoring word belongs, aggregating a text content that is in the value topic and that has a semantic distance smaller than a fourth threshold by taking a given personalized customized decision target as a constraint, and obtaining an evolution rule of the value topic according to time window analysis; performing “main body-description” chain structure representation on the value topic based on the personalized customized decision target to obtain multi-chain aggregated net structure topic representation; and converting an anchoring hit relation between words into a connection relation, performing topological persistent homology on the value semantic topological space by taking the optimized topic anchoring word as a constraint, adjusting a density of word connection in the semantic topological space, and forming multi-cluster net structure representation of the value semantic text on the basis if the connection density between the optimized topic anchoring word and related words in the value topic is greater than that between the optimized topic anchoring word and related words in other topics.

S6: repeating the steps S1-S5 on a plurality of cross-domain texts for anchoring and constraining to construct a value chain knowledge graph; specifically, in the value semantic topological space, performing knowledge representation under anchoring semantics on other cross-domain text corpora by the steps S1-S5, performing topological persistent homology on the cross-domain text based on a given decision target to obtain a semantic feature of value alignment in the cross-domain text, extracting a cross-domain and multi-body association relationship based on the semantic feature of the given decision target, and obtaining the value chain knowledge graph with texts as nodes and text association relationships as connections.

### Embodiment 2

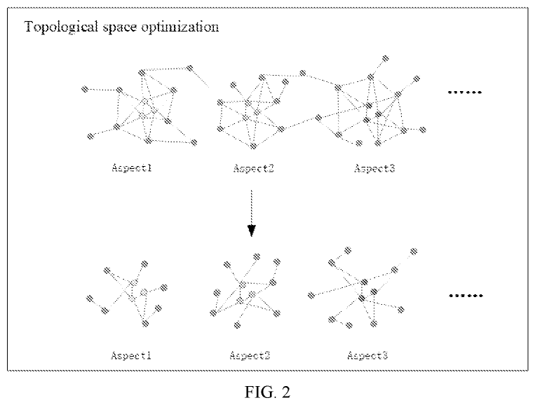

An embodiment of the present invention discloses a value chain knowledge discovery method under personalized customization, which takes the analysis of the personalized customized production of knives and scissors as an example, and comprises the following steps:
S1: Extracting a value anchoring seed word from a given domain text;
specifically, performing anonymization on a text of knife and scissor production technology, and segmenting words to obtain a text word sequence. The decision target topic is defined as follows: durability, safety, comfort, cleanliness and the like, a small amount of patent texts are tagged, part-of-speech extraction is performed to obtain a set of a concept noun and a description word of the topic, coding processing is performed on the concept noun and the description word by using a general text coding method to obtain a word text vector under a general corpus, and by calculating a distance between words within a topic, at least 3 value anchoring seed words with the closest semantic distance under each topic are selected, for example, the following seed words of knife face, stainless steel and cutting are selected from the topic “durability”; and the following seed words of protection, contraction and shell are selected from the topic “safety”.
S2: Constructing a text semantic topological space according to the value anchoring seed word;
specifically, calculating semantic distances between an anchoring seed word of each topic and other words in the given text; and removing words outside a given semantic distance range from the anchoring seed word, and converting a text measurement space taking the anchoring seed word as a center into a value semantic topological space through a given topological persistent homology parameter, as shown in FIG. 2.
S3: Expanding the value anchoring seed word to obtain an initial topic anchoring word set;
specifically, in a topic of a text semantic topological space, such as the topic of “durability”, measuring a semantic distance between one of the topic words “gap” and the 3 seed words of the topic, if the semantic distances between the “gap” and more than half of the seed words (namely 2 or more) are smaller than a given threshold di, considering that the “gap” hits the topic and can be used as an expansion word of the value anchoring seed word; and performing the above operation on each word in the topic “durability”, and finally obtaining an initial topic anchoring word set.
S4: Updating the anchoring seed word to obtain an optimized topic anchoring word set;
specifically, calculating semantic distances between any one of the words of the initial anchoring word set in the obtained topic “durability” such as “gap” and other anchoring words, counting the number of the anchoring words in the anchoring words with the semantic distances that are from the “gap” and that are smaller than the given semantic distance threshold di, and calculating the hit probability of “gap” formed by the ratio of the number of the anchoring words in the semantic distance to the total number of the anchoring word set; and performing hit probability calculation on each word of the topic anchoring word set, taking the first 3 words with the highest hit probability as new anchoring seed words, and repeating the determination of the initial topic anchoring word on this basis to obtain the optimized topic anchoring words.
S5: Establishing a value semantic text representation structure under anchoring constraint;
specifically, in the value semantic topological space, calculating semantic distances between the topic anchoring word “durability” and the contents of other patent texts for knives and scissors, and if the semantic distance between “wear resistance” and “wear” in the topic anchoring word is close in a latest patent text for knives and scissors, classifying the “wear resistance” into the topic “durability”; taking technical innovation optimization of the knife and scissor industry as a decision target, performing fusion association analysis on texts in the topic “durability”, and obtaining a net structure representation consisting of multiple chains such as “knife edge-wear resistance” and “stainless steel-oxidation resistance” according to semantic features of the topic anchoring words; and then performing persistent homology on the value semantic topological space by taking the topic anchoring words as constraints so as to perform discretization processing among the topics, for example, the connections of the words between the topic “durability” and the topic “safety” are reduced, and the discrimination among the topics is improved, so that the text presents a multi-cluster net structure with highly aggregated inside the topics and sparse connection among the topics.
S6: Anchoring and constraining a plurality of cross-domain texts to construct a value chain knowledge graph;
specifically, in the value semantic topological space, performing anchoring semantic representation with consumption demand mining as a decision target on a text of another domain, namely a comment text for knife and scissor commodity by the above same steps, so as to form a value chain cross-domain text data basis of “production technology and consumption demand” in the knife and scissor industry; and then, performing topological persistent homology on the cross-domain text by taking the personalized customization of the knife and scissor products as a decision target in a value semantic topological space to obtain a value alignment semantic feature that is consistent with the semantic of the decision target in the cross-domain text, for example, the patent text and the comment text pay attention to key semantics such as quality, safety and appearance of the knives and scissors, the association relationship among multiple main bodies in the cross-domain text is extracted based on the semantic features, and finally a value chain knowledge graph with text contents as nodes and association relationships among text as connections is formed. This can help knife and scissor manufacturers to quickly customize products based on their technical advantages to meet the personalized requirements of the users.

Since the device disclosed in the embodiment corresponds to the method disclosed in the embodiment, the description is relatively simple, and reference may be made to the partial description of the method.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

What is claimed is:

1. A value chain knowledge discovery method under a personalized customization, comprising the following steps:
S1: defining a value topic for a given domain text, and extracting a value anchoring seed word;
S2: constructing a value semantic topological space according to the value anchoring seed word;
S3: expanding the value anchoring seed word to obtain an initial topic anchoring word set;
S4: updating the initial topic anchoring word to obtain an optimized topic anchoring word set;
S5: obtaining a multi-cluster net structure representation of a value semantic text by taking an optimized topic anchoring word as a constraint; and
S6: repeating the steps S1-S5 on a plurality of cross-domain texts for anchoring and constraining to construct a value chain knowledge graph;
wherein the step S1 comprises:
performing a word segmentation on the given domain text to obtain a text word sequence and defining the value topic,
extracting a concept noun and a description word in the text word sequence as initial words,
performing a coding processing on the concept noun and the description word by using a general text coding method to obtain a word text vector under a general corpus,
calculating a semantic distance between every two initial words in the value topic, and
finding out at least 3 words with closest semantic distances from other initial word in each topic as value anchoring seed words;
wherein the step S2 comprises:
calculating a semantic distance between the value anchoring seed word and other words in the given domain text and removing a word with a semantic distance that is from the value anchoring seed word and that is larger than a first preset threshold, and
converting a text measurement space taking the value anchoring seed word as a center into the value semantic topological space through a preset topological persistent homology parameter;
wherein the step S4 comprises:
in a value topic of the value semantic topological space, selecting any one of the initial topic anchoring words,
counting semantic distances between the selected initial topic anchoring word and other initial topic anchoring words,
taking a number of other initial topic anchoring words with semantic distances that are from the selected initial topic anchoring word and that are smaller than a second preset threshold as a number of hits,
calculating a hit probability of each selected initial topic anchoring word in the initial topic anchoring word set according to the number of hits,
taking first 3 initial topic anchoring words with a highest hit probability as new anchoring seed words,
taking the new anchoring seed words as initial anchoring seed words, and
repeating the step S3 to obtain the optimized topic anchoring word set;
wherein the step S5 comprises:
in the value semantic topological space, calculating semantic distances between an optimized topic anchoring word and other words of the given domain text, classifying a word with a semantic distance that is from the optimized topic anchoring word and that is smaller than a third preset threshold into a value topic to which the optimized topic anchoring word belongs, aggregating a text content that is in the value topic and that has a semantic distance smaller than a fourth threshold by taking a given personalized customized decision target as a constraint, and obtaining an evolution rule of the value topic according to a time window analysis;
Performing a “main body-description” chain structure representation on the value topic based on the personalized customized decision target to obtain a multi-chain aggregated net structure topic representation; and
converting an anchoring hit relation between words into a connection relation, performing a topological persistent homology on the value semantic topological space by taking the optimized topic anchoring word as a constraint, adjusting a density of word connection in the value semantic topological space, and if a connection density between the optimized topic anchoring word and related words in the value topic is greater than that between the optimized topic anchoring word and related words in other topics, forming the multi-cluster net structure representation of the value semantic text on this basis;
wherein the step S6 comprises:
in the value semantic topological space, performing a knowledge representation under anchoring semantics on other cross-domain text corpora by the steps S1-S5,
performing a topological persistent homology on the cross-domain text based on a given decision target to obtain a semantic feature of value alignment in the cross-domain text,
extracting a cross-domain and multi-body association relationship based on the semantic feature of the given decision target, and
obtaining the value chain knowledge graph with texts as nodes and text association relationships as connections.

2. (canceled)

3. (canceled)

4. The value chain knowledge discovery method under the personalized customization according to claim 1, wherein the step S3 comprises:
in the value topic of the value semantic topological space, taking a number of value anchoring seed words with semantic distances that are from topic words and that are smaller than the first preset threshold as a number of hits of the topic words on the value anchoring seed words,
calculating an anchoring hit probability of the topic words in the value topic according to the number of hits, expanding the topic words with the anchoring hit probability larger than 50% into the value anchoring seed words as expansion words, and
obtaining the initial topic anchoring word set formed by the value anchoring seed words and the expansion words.

5. (canceled)

6. (canceled)

7. (canceled)
